(19) United States
(12) Patent Application Publication
(10) Pub. No.: US 2010/0027663 A1
(43) Pub. Date: Feb. 4, 2010

(54) INTELLEGENT FRAME SKIPPING IN VIDEO CODING BASED ON SIMILARITY METRIC IN COMPRESSED DOMAIN

(75) Inventors: Min Dai, San Diego, CA (US); Tao Xue, San Diego, CA (US); Chia-Yuan Teng, San Diago, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/248,825

(22) Filed: Oct. 9, 2008

Related U.S. Application Data
(60) Provisional application No. 61/084,534, filed on Jul. 29, 2008.

(51) Int. Cl. H04N 7/26

(52) U.S. Cl. 375/240.16; 375/240.01; 375/E07.123

(57) ABSTRACT

This disclosure provides intelligent frame skipping techniques that may be used by an encoding device or a decoding device to facilitate frame skipping in a manner that may help to minimize quality degradation due to the frame skipping. In particular, the described techniques may implement a similarity metric designed to identify good candidate frames for frame skipping. In this manner, noticeable reductions in the video quality caused by frame skipping, as perceived by a viewer of the video sequence, may be reduced relative to conventional frame skipping techniques. The described techniques advantageously operate in a compressed domain.

The present Application for Patent claims priority to Provisional Application No. 61/084,534 filed Jul. 29, 2008, and assigned to the assignee hereof and hereby expressly incorporated by reference herein.

### TECHNICAL FIELD

The disclosure relates to digital video coding and, more particularly, techniques for frame skipping in video encoding or video decoding.

### BACKGROUND

Many different video coding techniques have been developed for encoding and decoding of digital video sequences. The Moving Picture Experts Group (MPEG), for example, has developed several encoding standards including MPEG-1, MPEG-2 and MPEG-4. Other example coding techniques include those set forth in the standards developed by the International Telecommunication Union (ITU), such as the ITU-T H.263 standard, and the ITU-T H.264 standard and its counterpart, ISO/IEC MPEG-4, Part 10, i.e., Advanced Video Coding (AVC). These and other video coding techniques support efficient transmission of video sequences by encoding data in a compressed manner. Compression reduces the amount of data that needs to be transmitted between devices in order to communicate a given video sequence.

Video compression may involve spatial and/or temporal prediction to reduce redundancy inherent in video sequences. Intra-coding uses spatial prediction to reduce spatial redundancy of video blocks within the same video frame. Inter-coding uses temporal prediction to reduce temporal redundancy between video blocks in successive video frames. For inter-coding, a video encoder performs motion estimation to generate motion vectors indicating displacement of video blocks relative to corresponding prediction video blocks in one or more reference frames. The video encoder performs motion compensation to generate a prediction video block from the reference frame, and forms a residual video block by subtracting the prediction video block from the original video block being coded.

Frame skipping is commonly implemented by encoding devices and decoding devices for a variety of different reasons. In general, frame skipping refers to techniques in which the processing, encoding, decoding, transmission, or display of one or more frames is purposely avoided at the encoder or at the decoder. When frame skipping is used, the frame rate associated with a video sequence may be reduced, usually degrading the quality of the video sequence to some extent. For example, video encoding applications may implement frame skipping in order to meet low bandwidth requirements associated with communication of a video sequence. Alternatively, video decoding applications may implement frame skipping in order to reduce power consumption by the decoding device.

### SUMMARY

This disclosure provides intelligent frame skipping techniques that may be used by an encoding device or a decoding device to facilitate frame skipping in a manner that may help to minimize quality degradation due to the frame skipping. In particular, the described techniques may implement a similarity metric designed to identify good candidate frames for frame skipping. According to the disclosed techniques, noticeable reductions in the video quality caused by frame skipping, as perceived by a viewer of the video sequence, may be reduced relative to conventional frame skipping techniques. The described techniques may be implemented by an encoder in order to reduce the bandwidth needed to send a video sequence. Alternatively, the described techniques may be implemented by a decoder in order to reduce power consumption. In the case of the decoder, the techniques may be implemented to skip decoding altogether for one or more frames, or merely to skip post processing and display of one or more frames.

The described techniques advantageously operate in a compressed domain. In particular, the techniques may rely on coded data in the compressed domain in order to make frame skipping decisions. This data may include encoded syntax identifying video block types, and other syntax such as motion information identifying the magnitude and direction of motion vectors. In addition, this data may include coefficient values associated with video blocks, i.e., transformed coefficient values. Based on this information in the compressed domain, the similarity metric is defined and then used to facilitate selective frame skipping. In this way, the techniques of this disclosure execute frame skipping decisions in the compressed domain rather than the decoded pixel domain, and promote frame skipping that will not substantially degrade perceived quality of the video sequence.

In one example, the disclosure provides a method that comprises generating a similarity metric that quantifies similarities between a current video frame and an adjacent frame of a video sequence, wherein the similarity metric is based on data within a compressed domain indicative of differences between the current frame and the adjacent frame, and skipping the current video frame subject to the similarity metric satisfying a threshold.

In another example, the disclosure provides an apparatus comprising a frame skip unit that generates a similarity metric that quantifies similarities between a current video frame and an adjacent frame of a video sequence, wherein the similarity metric is based on data within a compressed domain indicative of differences between the current frame and the adjacent frame, and causes the apparatus to skip the current video frame subject to the similarity metric satisfying a threshold.

In another example, the disclosure provides a device comprising means for generating a similarity metric that quantifies similarities between a current video frame and an adjacent frame of a video sequence, wherein the similarity metric is based on data within a compressed domain indicative of differences between the current frame and the adjacent frame, and means for skipping the current video frame subject to the similarity metric satisfying a threshold.

In another example, the disclosure provides an encoding device comprising a frame skip unit that generates a similarity metric that quantifies similarities between a current video frame and an adjacent frame of a video sequence, wherein the similarity metric is based on data within a compressed domain indicative of differences between the current frame and the adjacent frame, and a communication unit that skips transmission of the current video frame subject to the similarity metric satisfying a threshold.

In another example, the disclosure provides an decoding device comprising a communication unit receives compressed video frames of a video sequence, and a frame skip unit that generates a similarity metric that quantifies similarities between a current video frame and an adjacent frame of the video sequence, wherein the similarity metric is based on data within a compressed domain indicative of differences between the current frame and the adjacent frame, and causes the device to skips of the current video frame subject to the similarity metric satisfying a threshold.

The techniques described in this disclosure may be implemented in hardware, software, firmware, or a combination thereof. If implemented in software, the software may be executed by one or more processors. The software may be initially stored in a computer readable medium and loaded by a processor for execution. Accordingly, this disclosure contemplates computer-readable media comprising instructions to cause one or more processors to perform techniques as described in this disclosure.

For example, in some aspects, the disclosure provides a computer-readable medium comprising instructions that when executed cause a device to generate a similarity metric that quantifies similarities between a current video frame and an adjacent frame of a video sequence, wherein the similarity metric is based on data within a compressed domain indicative of differences between the current frame and the adjacent frame, and skip the current video frame subject to the similarity metric satisfying a threshold.

The details of one or more aspects of the disclosed techniques are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a video encoding and decoding system configured to implement frame skipping in a decoder device consistent with this disclosure.

FIG. 2 is a block diagram illustrating a video encoding and decoding system configured to implement frame skipping in an encoder device consistent with this disclosure.

FIG. 3 is a block diagram illustrating an example of a video decoder device configured to implement frame skipping according to the techniques of this disclosure.

FIG. 4 is a flow diagram illustrating a frame skipping technique that may be executed in a decoder device.

FIG. 5 is a flow diagram illustrating a frame skipping technique that may be executed in an encoder device.

FIG. 6 is a flow diagram illustrating a technique for generating an exemplary similarity metric and performing frame skipping based on the similarity metric.

FIG. 7 is a flow diagram illustrating a frame skipping technique that may be executed by a decoder device.

### DETAILED DESCRIPTION

This disclosure provides intelligent frame skipping techniques that may be used by an encoding device or a decoding device to facilitate frame skipping in a manner that may help to minimize quality degradation due to the frame skipping. In particular, this disclosure describes the use of a similarity metric designed to identify good candidate frames for frame skipping. In a general sense, the similarity metric may be used to identify frames that are sufficiently similar to adjacent frames that were not skipped. The adjacent frames may be previous or subsequent frames of a sequence, which are temporally adjacent to the current frame being considered. By identifying whether current frames are good candidates for frame skipping, frame skipping may only cause negligible impacts on quality of the displayed video sequence. Moreover, by using the similarity metric to facilitate frame skipping decisions, noticeable reductions in the video quality caused by frame skipping, as perceived by a viewer of the video sequence, may be reduced relative to conventional frame skipping techniques.

The described techniques may be implemented by an encoder in order to reduce the bandwidth needed to send a video sequence. Alternatively, the described techniques may be implemented by a decoder in order to reduce power consumption. For power reduction at the decoder, the techniques may be implemented to skip decoding altogether for one or more frames, or merely to skip post processing and/or display of one or more frames that have been decoded. Post processing can be very power intensive. Consequently, even if frames have been decoded, it may still be desirable to skip post processing and display of such frames to reduce power consumption.

The described techniques advantageously operate in a compressed domain. Video data in the compressed domain may include various syntax elements, such as syntax that identifies video block types, motion vector magnitudes and directions, and other characteristics of the video blocks. Moreover, in the compressed domain, the video data may comprise compressed transform coefficients rather than uncompressed pixel values. The transform coefficients, such as discrete cosine transform (DCT) coefficients or conceptually similar coefficients, may comprise a collective representation of a set of pixel values in the frequency domain. In any case, the techniques of this disclosure may rely on coded data in the compressed domain in order to make frame skipping decisions. In particular, based on this information in the compressed domain, the similarity metric is defined for a frame, and then compared to one or more thresholds in order to determine whether that frame should be skipped. In some cases, the similarity metric defined based on data in the compressed domain may be used to facilitate frame skipping decisions in the decoded non-compressed domain, e.g., by controlling frame skipping following the decoding process.

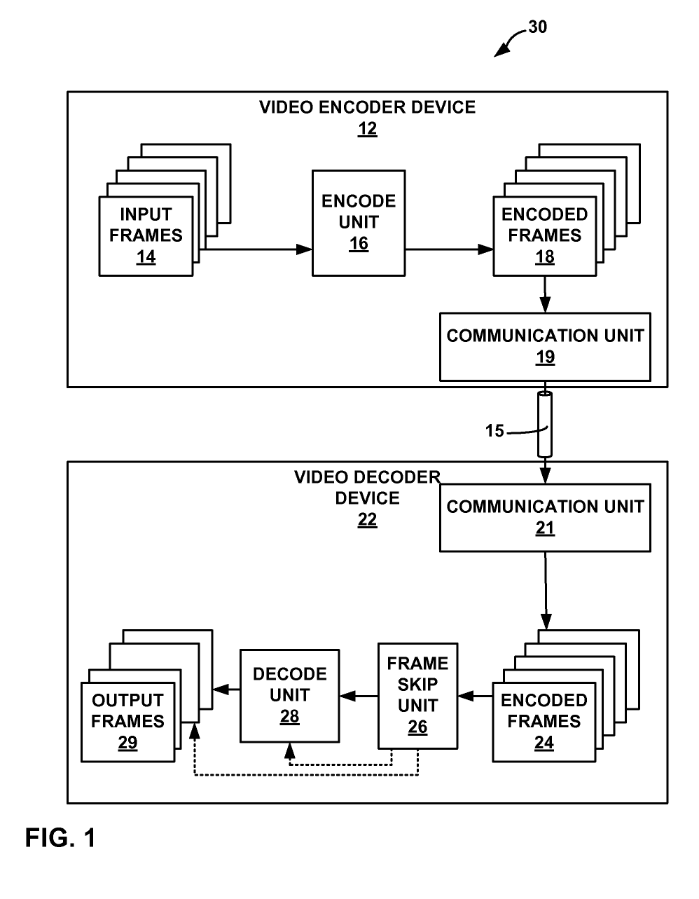

FIG. 1 is a block diagram illustrating a video encoding and decoding system 10 configured to implement frame skipping in a video decoder device 22 consistent with this disclosure. As shown in FIG. 1, system 10 may include a video encoder device 12 and a video decoder device 22, each of which may be generally referred to as a video coder device. In the example of FIG. 1, video encoder device 12 encodes input video frames 14 to produce encoded video frames 18. In particular, encode unit 16 may perform one or more video coding techniques, such as intra-predictive or inter-predictive coding on input frames 14. Encode unit 16 may also perform one or more transforms, quantization operations, and entropy coding processes. Communication unit 19 may transmit encoded video frames 18 to communication unit 21 of video decoder device 22 via a communication channel 15.

Video decoder device 22 receives encoded frames 24, which may comprise encoded frames 18 sent from source device 12, possibly including one or more corrupted frames. In the example of FIG. 1, video decoder device 22 includes a frame skip unit 26, which executes the frame skipping techniques of this disclosure in order to conserve power in video decoder device 22. Frame skip unit 26 identifies one or more frames that can be skipped. Such frame skipping may involve skipping of the decoding of one or more frames by decode unit 28. Alternatively, the frame skipping may involve skipping of post processing and/or display of one or more frames following decoding of the frames by decode unit 28. In either case, output frames 29 may include a subset of encoded frames 24 insofar as one or more of encoded frames 24 are skipped in the decoding, post processing, and/or display of output frames 29.

As outlined in greater detail below, the frame skipping decisions may be performed based on compressed data, e.g., data associated with encoded frames 24. Again, such data may include syntax and possibly transform coefficients associated with encoded frames 24. Frame skip unit 26 may generate a similarity metric based on the encoded data in order to determine whether a current frame is sufficiently similar to the previous frame in the video sequence, which may indicate whether or not the current frame can be skipped without causing substantial quality degradation.

Encoded frames 24 may define a frame rate, e.g., 15, 30, or 60 frames per second (fps). Frame skip unit 26 may effectively reduce the frame rate associated with output frames 29 relative to encoded frames 24 by causing one or more frames to be skipped. Again, frame skipping may involve skipping the decoding of one or more frames, skipping any post processing of one or more frames following the decoding of all frames, or possibly skipping the display of one or more frames following the decoding and post processing of all frames. Post processing units are not illustrated in FIG. 1 for simplicity, but are discussed in greater detail below.

Communication unit 19 may comprise a modulator and a transmitter, and communication unit 21 may comprise a demodulator and a receiver. Encoded frames 18 may be modulated according to a communication standard, e.g., such as code division multiple access (CDMA) or another communication standard or technique, and transmitted to destination device communication unit 21 via communication unit 19. Communication units 19 and 21 may include various mixers, filters, amplifiers or other components designed for signal modulation, as well as circuits designed for transmitting data, including amplifiers, filters, and one or more antennas. Communication units 19 and 21 may be designed to work in a symmetric manner to support two-way communication between devices 12 and 22. Devices 12 and 22 may comprise any video encoding or decoding devices. In one example, devices 12 and 22 comprise wireless communication device handsets, such as so-called cellular or satellite radiotelephones. In the case of reciprocal two-way communication between devices 12 and 22, encode unit 16 and decode unit 28 of devices 12 and 22 may each comprise an encoder/decoder (CODEC) capable of encoding and decoding video sequences.

Communication channel 15 may comprise any wireless or wired communication medium, such as a radio frequency (RF) spectrum or one or more physical transmission lines, or any combination of wireless and wired media. Communication channel 15 may include a packet-based network, such as a local area network, a wide-area network, or a global network such as the Internet. In addition, communication channel 15 may include a wireless cellular communication network, including base stations or other equipment designed for the communication of information between user devices. Basically, communication channel 15 represents any suitable communication medium, or collection of different communication media, devices or other elements, for transmitting video data from video encoder device 12 to video decoder device 22.

Video encoder device 12 and video decoder device 22 may be implemented as one or more microprocessors, digital signal processors (DSPs), application specific integrated circuits (ASICs), field programmable gate arrays (FPGAs), discrete logic, software, hardware, firmware or any combinations thereof.

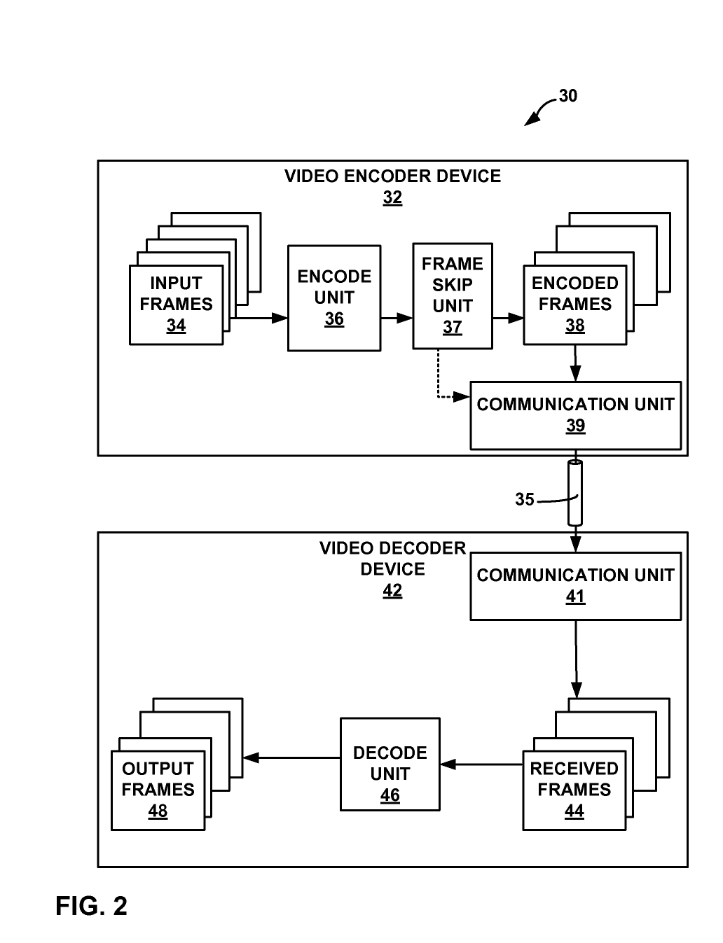

FIG. 2 is a block diagram illustrating a video encoding and decoding system 30 configured to implement frame skipping in a video encoder device 32 consistent with this disclosure. System 30 of FIG. 2 is similar to system 10 of FIG. 1. However, in system 30, frame skip unit 37 is included in video encoder device 32 rather than video decoder device 42. In this case, video encoder device 32 performs frame skipping in order to reduce the bandwidth needed to send a video sequence. In particular, by performing intelligent frame skipping in video encoder device 32, the amount of video data sent over communication channel 35 can be reduced, while mitigating quality degradation.

Video encoder device 32 invokes encode unit 36 to encode input frames 34. Frame skip unit 37 performs frame skipping in the compressed domain in order to remove one or more frames from encoded frames 38. Communication unit 39 modulates and transmits encoded frames 38 to communication unit 41 of video decoder device 42 via communication channel 35.

Video decoder device 42 invokes decode unit 46 to decode received frames 44, which correspond to encoded frames 38, possibly with corruption to one or more of the frames due to information loss during the communication of the frames. Output frames 48 can be output by video decoder device 42, e.g., via a display. Post processing may be performed prior to output of output frames 48, but post processing components are not illustrated in FIG. 2 for simplicity. The various units and elements shown in FIG. 2 may be similar or identical to similarly named elements in FIG. 1, which are explained in greater detail above.

Systems 10 and 30 may be configured for video telephony, video streaming, video broadcasting, or the like. Accordingly, reciprocal encoding, decoding, multiplexing (MUX) and demultiplexing (DEMUX) components may be provided in each of the encoding devices 12, 32 and decoding devices 22, 42. In some implementations, encoding devices 12, 32 and decoding devices 22, 42 may comprise video communication devices such as wireless mobile terminals equipped for video streaming, video broadcast reception, and/or video telephony, such as so-called wireless video phones or camera phones.

Such wireless communication devices include various components to support wireless communication, audio coding, video coding, and user interface features. For example, a wireless communication device may include one or more processors, audio/video encoders/decoders (CODECs), memory, one or more modems, transmit-receive (TX/RX) circuitry such as amplifiers, frequency converters, filters, and the like. In addition, a wireless communication device may include image and audio capture devices, image and audio output devices, associated drivers, user input media, and the like. The components illustrated in FIGS. 1 and 2 are merely those needed to explain the intelligent frame skipping techniques of this disclosure, but encoding devices 12, 32 and decoding devices 22, 42 may include many other components.

Encoding devices 12, 32 and decoding devices 22, 42, or both, may comprise or be incorporated in a wireless or wired communication device as described above. Also, encoding devices 12, 32 and decoding devices 22, 42, or both may be implemented as integrated circuit devices, such as an integrated circuit chip or chipset, which may be incorporated in a wireless or wired communication device, or in another type of device supporting digital video applications, such as a digital media player, a personal digital assistant (PDA), a digital television, or the like.

Systems 10 and 30 may support video telephony according to the Session Initiated Protocol (SIP), ITU-T H.323 standard, ITU-T H.324 standard, or other standards. Encoding devices 12, 32 may generate encoded video data according to a video compression standard, such as MPEG-2, MPEG-4, ITU-T H.263, ITU-T H.264, or MPEG-4, Part 10. Although not shown in FIGS. 1 and 2, encoding devices 12, 32 and decoding devices 22, 42 may comprise integrated audio encoders and decoders, and include appropriate hardware and software components to handle both audio and video portions of a data stream.

The various video frames illustrated in FIGS. 1 and 2 may include Intra frames (I frames), predictive frames (P frames), and bi-directional predictive frames (B frames). I frames are frames that completely encode all video information using spatial coding techniques, whereas P and B frames are examples of predictively coded frames, which are coded based on temporal coding techniques. The encoded frames may comprise information describing a series of video blocks that form a frame. The video blocks, which may comprise 16 by 16 macroblocks, smaller macroblock partitions, or other blocks of video data, may include bits that define pixel values, e.g., in luminance (Y), chrominance red (Cr) and chrominance blue (Cb) color channels. Frames that are predictive frames generally serve as reference frames for decoding of other inter-coded frames in a video sequence, i.e., as a reference for motion estimation and motion compensation of another frame. Depending upon the coding standard, any frames may be predictive frames used to predict the data of other frames. However, in some standards, only I frames and P frames may be predictive frames, and B frames comprise non-predictive frames that cannot be used to predict data of other frames.

Following any coding process, the bits that define pixel values of video blocks may be converted to transform coefficients that collectively represent pixel values in a frequency domain. Compressed video blocks of compressed frames may comprise blocks of transform coefficients that represent residual data. The compressed video blocks also include syntax that identifies the type of video block, and for inter-coded blocks a motion vector magnitude and direction. The motion vector identifies a predictive block, which can be combined with the residual data in the pixel domain in order to the decoded video block.

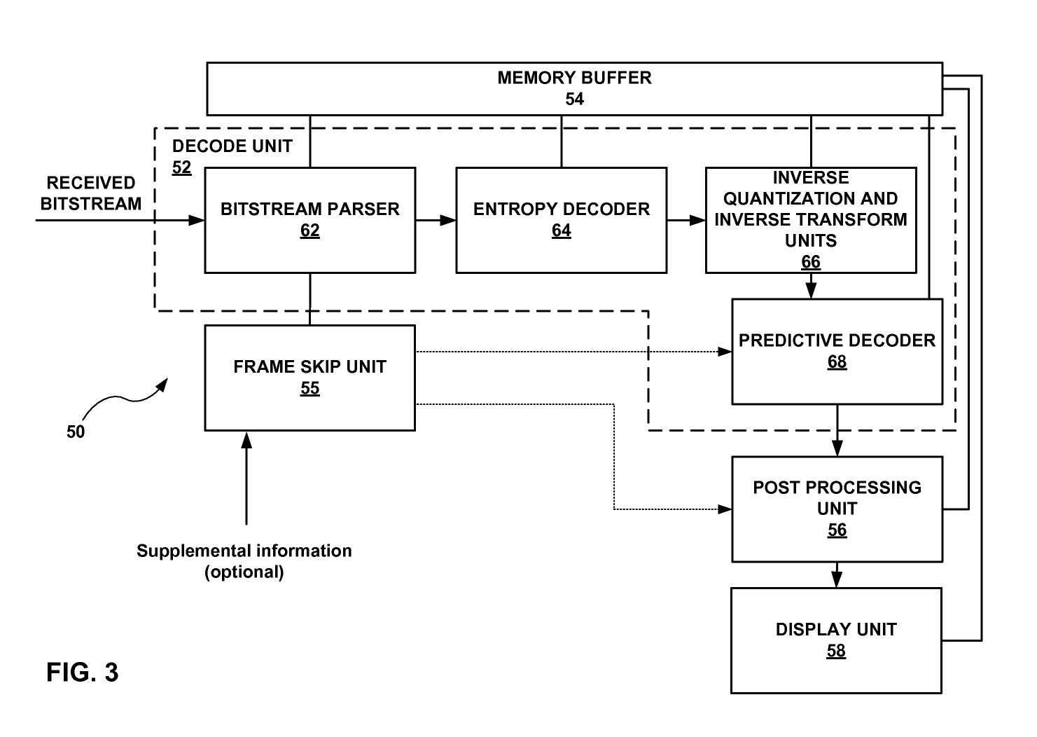

Power consumption is a significant concern for video playback on any power-constrained device. FIG. 3 is an exemplary block diagram of such a power-constrained decode device 50. Device 50 includes a decode unit 52, an internal memory buffer 54, a post processing unit 56, and a display unit 58. In addition, device 50 includes a frame skip unit 55 that performs one or more of the techniques of this disclosure in order to skip frames for power conservation. Device 50 may be a battery powered device, in which case one or more batteries (not shown) power the various units illustrated in FIG. 3. Device 50 may also include a communication unit (not shown) that receives the bitstream of encoded data from another device.

Decode unit 52 receives a bitstream, e.g., from a communication unit associated with device 50. During the decoding and reconstruction process, decode unit 52 may fetch and save any reference frames from an external memory (not shown) to an internal memory buffer 54. Memory buffer 54 is called “internal” insofar as it may be formed on a same integrated circuit as decode unit 52, in contrast to a so-called “external memory,” which may be formed on a different integrated circuit than decode unit 52. The location and format of the memory, however, may be different in different examples and implementations.

Upon receiving a bitstream, bitstream parser 62 parses the bitstream, which comprises encoded video blocks in a compressed domain. For example, bitstream parser 62 may identify encoded syntax and encoded coefficients of the bitstream. Entropy decoder 64 performs entropy decoding of the bitstream, e.g., by performing content adaptive variable length coding (CAVLC) techniques, context adaptive binary arithmetic coding (CABAC) techniques, or other variable length coding techniques. Inverse quantization and inverse transformation unit 66 may transform the data from a frequency domain back to a pixel domain, and may de-quantize the pixel values.

Predictive decoder 68 performs predictive-based decoding techniques, such as spatial-based decoding of intra video blocks, and temporal-based decoding of inter video blocks. Predictive decoder 68 may include various spatial based components that generate spatial-based predictive data, e.g., based on the intra mode of video blocks, which may be identified by syntax. Predictive decoder 68 may also include various temporal based components, such as motion estimation and motion compensation units, that generate temporal-based predictive data, e.g., based on motion vectors or other syntax. Predictive decoder 68 identifies a predictive block based on syntax, and reconstructs the original video block by adding the predictive block to an encoded residual block of data that is included in the received bitstream. Predictive decoder 68 may predictively decode all of the video blocks of a frame in order to reconstruct the frame.

Post processing unit 56 performs any post processing on reconstructed frames. Post processing unit 56 may include components for any of a wide variety of post processing tasks. Post processing tasks may include such things as scaling, blending, cropping, rotation, sharpening, zooming, filtering, de-flicking, de-ringing, de-blocking, resizing, de-interlacing, de-noising, or any other imaging effect that may be desired following reconstruction of a video frame. Following the post processing by post processing unit 56, the image frame is temporarily stored in memory buffer 54, and displayed on display unit 58.

In accordance with this disclosure, device 50 includes frame skip unit 55. Frame skip unit 55 identifies one or more frames that can be skipped. In particular, frame skip unit 55 examines the received and parsed bitstream, e.g., parsed by bitstream parser 62. At this point, the received bitstream is still in a compressed domain. Again, such data may include syntax and possibly transform coefficients associated with encoded frames. Frame skip unit 55 may generate a similarity metric based on the encoded data. Frame skip unit 55 may compare the similarity metric to one or more thresholds, in order to determine whether the similarity metric satisfies the thresholds, e.g., typically by comparing the similarity metric to one or more thresholds to determine whether the similarity metric exceeds one or more of the thresholds. In this way, the similarity metric is a mechanism that allows frame skip unit 55 to quantify whether a current frame is sufficiently similar to the previous non-skipped frame in the video sequence, which may indicate whether or not the current frame can be skipped without causing substantial quality degradation.

The frame skipping may involve skipping of the decoding of one or more frames by predictive decoder 68. In this case, frame skip unit 55 may send control signals to predictive decoder 68 to suspend decoding of the one or more frames identified by frame skip unit 55. Alternatively, the frame skipping may involve skipping of post processing of one or more frames following decoding of the frames. In this case, frame skip unit 55 may send control signals to post processing unit 56 to suspend post processing of the one or more frames identified by frame skip unit 55. In each of these cases, display of the one or more skipped frames by display unit 58 is also suspended. Control signals may also be provided to display unit 58, if needed, in order to cause frame skipping by display unit 58. However, control signals may not be needed for display unit 58, particularly if processing of a frame is suspended earlier, e.g., by suspending decoding or post processing of that frame. Still, this disclosure contemplates frame skipping at predictive decoder 68, post processing unit 56 or display unit 55, and control signals may be provided from frame skip unit 55 to any of these units to cause such frame skipping.

In some examples, frame skip unit 55 may identify good candidates for frame skipping, and may inform predictive decoder 68, post processing unit 56, or both of the good candidates. In this case, predictive decoder 68 and/or post processing unit 56 may actually execute the decisions whether to skip frames or not, e.g., based on available power. Accordingly, frame skip unit 55 may identify good candidates for frame skipping, and facilitate informed frame skipping decisions by other units such as predictive decoder 68, post processing unit 56, or both.

Sometimes, it is undecided or unknown whether frame skipping should be performed until after the video blocks of frames have been reconstructed by predictive decoder 68. In such cases, frame skipping at post processing unit 56 may still achieve substantial and needed power conservation. According to the techniques of this disclosure, frame skip unit 55 may determine whether frames are good candidates for frame skipping prior to such frames being decoded and reconstructed. These determinations may be used prior to the frame decoding, or following frame decoding in some cases. Frame skip unit 55 operates on data in a compressed domain very early in the processing of such frames. The identification of good candidates for frame skipping, by frame skipping unit 55, may be used at any stage of the later processing if power conservation is needed. In any case, operating in the compressed domain for frame skipping decisions may use less power than operating in an uncompressed domain. Therefore, even if frame skipping occurs following de-compression of the data, it may be desirable to make the frame skipping decisions based on un-compressed data.

In one example, frames of data reconstructed by predictive decoder 68 may comprise frames of 320 pixels by 240 pixels at a 1.5× frame rate, where x is a real number. Assuming that post processing of unit 56 performs scaling from QVGA to VGA, the output of post processing unit 56 may comprise frames of 640 pixels by 480 pixels at a 3× frame rate. In this case, post processing may consume significant power. Therefore, suspending the post processing and skipping a frame after predictive decoding of the frame may still be desirable, particularly when it is not known whether the frame should be skipped until after the predictive decoding process. Furthermore, since the display of frames by display unit 58 also consumes a significant amount of power, reducing the number of displayed frames may be a good way to reduce power consumption in device 50 even when it is not known whether the frame should be skipped until after the predictive decoding process.

In one example, decoder unit 52 may comply with the ITU-T H.264 standard, and the received bitstream may comprise an ITU-T H.264 compliant bitstream. Bitstream parser 62 parses the received bitstream to separate syntax from the bitstream, and variable length decoder 64 performs variable length decoding of the bitstream to generate quantized transform coefficients associated with residual video blocks. The quantized transform coefficients may be stored in memory buffer 54 via a direct memory access (DMA). Memory buffer 54 may comprise part of a CODEC processor core. Motion vectors and other control or syntax information may also be written into memory buffer, e.g., using a so-called aDSP EXP interface.

Inverse quantization and inverse transform unit 66 de-quantizes the data, and converts the data to a pixel domain. Predictive decoder 68 performs motion estimated compensation (MEC), and may possibly perform de-block filtering. Predictive decoder 68 then writes the reconstructed frames back to memory buffer 68. During the entire process, device 50 can be programmed to save power by skipping one or more frames, as described herein. The power consumption of video decoder 52 may be roughly proportional to the rendering frame rate.

The fewer frames that are decoded, post-processed, and/or displayed, the more power is saved. However, when fewer frames are displayed, video quality degradation occurs. In other words, reproduced sequences having lower frame rates usually have lower quality relative to sequences at comparatively higher frame rates, assuming that the rest of the video characteristics are similar. The techniques of this disclosure may reduce or eliminate such quality reductions when frame skipping occurs.

One basic goal of the techniques described herein is to save power by reducing the display frame rate without incurring a substantial penalty in visual quality. In order to limit quality degradation, the proposed power-saving frame selecting scheme uses a similarity metric in order to make frame skipping decisions.

The frame skipping techniques may follow some or all of the following rules in order to make frame skipping effective in terms of eliminating quality degradation. For frame skipping by predictive decoder 68, there may be a few basic rules. First, if a frame is a non-reference frame that is not used to predict other frames, and if abandoning the frame does not cause quality degradation (e.g., no jerkiness), predictive decoder 68 may skip the frame at the direction of frame skip unit 55. Second, if a frame is a reference frame that is used to predict another frame, but is badly corrupted, predictive decoder 68 may skip the frame at the direction of frame skip unit 55. Otherwise, predictive decoder 68 may decode and reconstruct all of the video blocks of a frame in order to reconstruct the frame.

For frame display, there may also be basic rules. For example, frame skip unit 55 may check the similarity of a to-be-displayed frame relative to an adjacent frame, e.g., a previously displayed frame or a subsequently displayed frame of a video sequence. If the to-be-displayed frame is very similar to the adjacent non-skipped frame, decoding by decode unit 68 may be avoided, post processing by post processing unit 56 may be avoided, and/or display of the to-be-displayed frame by display unit 58 may be avoided. The similarity metric discussed in greater detail below may facilitate this similarity check, and in some cases may be used to facilitate frame skipping decisions for predictive decoder 68 and post processing unit 56. However, it may be desirable to not consecutively skip more than a defined number of frames and, therefore, the components of device 50 may define a lower threshold for the frame rate. In this case, frame skip unit 55 may not cause any frame skipping if such frame skipping would cause the frame rate to fall below this lower threshold for the frame rate. Also, even at a given frame rate, it may also be desirable not to skip a defined number of frames, as this can cause jerkiness even if the overall frame rate remains relatively high. Frame skip unit 55 may determine such cases, and control frame skipping in a manner that promotes video quality.

To some extent, the inclusion of frame skip unit 55 adds to the power consumption of device 50. Therefore, to mitigate this power consumption caused by frame skipping decisions, similarity checks between to-be-displayed frames and previously displayed frames should be relatively simple. One way to keep this check simple is to execute similarity comparisons based solely on compressed domain parameters. In this case, similarity checks between to-be-displayed frames and previously displayed frames can be done based on compressed syntax elements, such as data indicative of video block types, and motion vector magnitudes and directions. If residual data is examined for similarity checks, the similarity checks can be made based on compressed transform coefficients in the transformed domain, rather than uncompressed pixel values. The disclosed techniques may only need to count the number of non-zero coefficients in a frame, as this may provide a useful input as to whether the frame is similar to an adjacent frame. Thus, the actual values of any non-zero coefficients may not be important to frame skip unit 55; rather, frame skip unit 55 may simply count the number of non-zero coefficients.

The differences between two neighboring frames are usually caused by motion or scene changes. By skipping frames that have similar content to previous frames, perceptual quality degradation may be limited. Any variety of the following information may be used to facilitate the similarity check in order for frame skip unit 55 to identify good candidates for frame skipping. A similarity metric may be defined based on one or more of the following factors.

Frame type and video block type are two factors that may be included in a similarity metric that quantifies similarities between adjacent frames and facilitates intelligent frame skipping decisions. For example, it may always be prudent to keep (.i.e., avoid skipping of) any I-frames. Also, if any P or B frames have a large percentage of Intra macroblocks, this usually means that such P or B frames are poor candidates for frame skipping and may have different content than the previous frame.

In MPEG-2 or MPEG-4 coding, a large percentage of skipped macroblocks may indicate that a current frame is very similar to the previous frame. Skipped macroblocks within a coded frame are blocks indicated as being “skipped” for which no residual data is sent. Skipped macroblocks may be defined by syntax. For these types of blocks, interpolations, extrapolations, or other types of data reconstruction may be performed at the decoder without the help of residual data. In ITU-T H.264, however, a large number of skipped macroblocks only means that the motion of these macroblocks is similar to its neighboring macroblocks. In this case, the motion of neighboring macroblocks may be imputed to skipped macroblocks. In accordance with this disclosure, the number of skipped macroblocks and the corresponding motion directions may be considered in order to detect motion smoothness. If a video sequence defines slow but panning motion, human eyes might easily notice effects of frame skipping. Therefore, slow panning motion is typically a poor scenario for invoking video frame skipping.

Motion types may also be used by frame skip unit 55 to facilitate frame skipping decisions. For motion type, frame skip unit 55 may check motion vector magnitude and motion vector direction to help decide whether the frame should be skipped. Usually, slow motion sequences are less sensitive to frame skipping. However, as mentioned earlier, slow panning sequences are sensitive to frame skipping. Frame skip unit 55 may also consider the number of non-zero coefficients for each non-Intra macroblock in making frame skipping decisions, and may combine a check on the number of non-zero coefficients with the quantization parameter value of the macroblock since higher levels of quantization naturally results in more zero-value coefficients and fewer non-zero coefficients.

If, for a given macroblock, the quantization parameter value is not large, and the number of non-zero coefficients is small, this tends to indicate that the macroblock is very similar to its co-located prediction block. If the quantization parameter value for the macroblock is small, but the number of non-zero coefficients is large, it means that the motion vector is not very reliable or that this macroblock is very different from its co-located prediction block. The distribution of quantization parameters associated with the different video blocks of a frame may be used by frame skip unit 55 to help determine whether frame skipping should be used for that frame. If the quantization parameter is too high for a particular macroblock, the information obtained from the compressed domain for that macroblock might not be accurate enough to aid in the similarity check. Therefore, it may be desirable to impose a quantization parameter threshold on the quantization parameter such that only macroblocks coded with a sufficiently low quantization parameter are considered and used in the similarity metric calculation.

Frame rate is another factor that may be used by frame skip unit 55 to help determine whether frame skipping should be used. The higher the frame rate, the more power that device 50 consumes for the decoding, post processing and display of frames. If the bitstream has a high frame rate (e.g., 30 frames per second or higher), selective frame skipping may save more power than when the bitstream has a low frame rate (e.g., less than 30 frames per second). Put another way, higher frame rates may provide frame skip unit 55 with more flexibility to save power in device. For example, if the lower bound of frame rate is 15 frames per second, frame skip unit 55 may have more flexibility to save power in device 50 when working with an original video sequence of 60 frames per second than could be saved working with an original video sequence of 30 frames per second.

Supplemental information may also be used by frame skip unit 55 to help determine whether frame skipping should be used. In the illustration of FIG. 3, supplemental information is shown as optional input to frame skip unit 55. As an example, upper layer information (such as control layer information associated with the modulation used to communicate data) may be sent with video frames to indicate whether one or more frames have been corrupted. If a frame is corrupted (e.g., as determined by such supplemental information), frame skip unit device 50 may prefer frame skipping rather than decoding, post processing, and/or displaying that frame.

Considering the totality of these factors discussed above, frame skip unit 55 may define and use a similarity metric (“SM”). In particular, the similarity quantifies similarities between the current video frame to be displayed and the previous video frame of the video sequence in order to determine whether that current frame is a good candidate for frame skipping. A current frame is skipped when the similarity metric satisfies one or more thresholds. The similarity metric and thresholds are typically defined such that the value of the similarity metric satisfies a given threshold when the value of the similarity metric exceeds the value of the given threshold. However, alternatively, the similarity metric and thresholds could be defined in other ways, e.g., such that the value of the similarity metric satisfies the given threshold when the value of the similarity metric is less than the value of the given threshold.

The similarly metric may be based on percentages associated with video blocks of the frame. For example, the similarly metric may be based on a percentage of intra video blocks in the current video frame, a percentage of video blocks in the current video frame that have motion vectors that exceed a motion vector magnitude threshold, a percentage of video blocks in the current video frame that have motion vectors that are sufficiently similar in direction as quantified by a motion vector direction threshold, and a percentage of video blocks in the current video frame that include fewer non-zero transform coefficients than one or more non-zero coefficient thresholds. Moreover, the one or more non-zero coefficient thresholds may be functions of one or more quantization parameters associated with the video in the current video frame.

In one example, the similarly metric (SM) generated by frame skip unit 55 comprises:

SM=W1*IntraMBs %+W2*MVs_Magnitude %+W3*MVs_Samedirection %+W4*Nz %.

W1, W2, W3 and W4 are weight factors that may be defined and applied to the different terms of the similarity metric. IntraMBs % may define the percentage of intra video blocks in the current video frame. MVs_Magnitude % may define the percentage of motion vectors associated with the current video frame that exceed the motion vector magnitude threshold. Frame skip unit 55 may count motion vectors that have magnitudes that exceed a pre-defined motion vector magnitude threshold in order to define MVs_Magnitude %.

MVs_Samedirection % may define a percentage of motion vectors associated with the current video frame that are sufficiently similar to one another, as quantified by the motion vector direction threshold. Like the motion vector magnitude threshold, the motion vector direction threshold may be pre-defined. The motion vector direction threshold establishes a level of similarity associated with motion vectors within a frame, e.g., an angle of difference, for which two or more motion vectors may be considered to have similar directions.

Nz % may define a percentage of video blocks in the current video frame that include fewer non-zero transform coefficients than the one or more non-zero coefficient thresholds. Like the other thresholds associated with the similarity metric, the non-zero coefficient thresholds may be pre-defined. Moreover, the non-zero coefficient thresholds may be functions of one or more quantization parameters associated with the video blocks in the current video frame. Nz % could be replaced by the term f_{QP}(nZ) % to indicate that nZ depends on thresholds defined by one or more quantization parameters.

The weight factors W1, W2, W3 and W4 may be pre-defined based on analysis of frame skipping in one or more test video sequences. In some cases, W1, W2, W3 and W4 are predefined to have different values for different types of video motion based on analysis of frame skipping in one or more test video sequences. Accordingly, frame skip unit 55 may examine the extent of video motion of a video sequence, and select the weight factors based on such motion. Test sequences may be used to empirically define one or more weight factors W1, W2, W3 and W4, possibly defining different factors for different levels of motion. In this way, weight factors can be defined in a manner that promotes an effective symmetry metric in terms of the symmetry metric being able to identify video frames that look similar to human observers. The various terms and weight factors of the similarity metric may account for the various factors and considerations discussed above.

If desired, the similarly metric may also be based on a percentage of video blocks in the current video frame that comprise skipped video blocks within the current video frame. Moreover, other factors or values discussed above may be used to define the similarity metric. In any case, the similarity metric quantifies similarities between a current video frame and the previous video frame (or other adjacent video frame). As the value of the similarity metric increases, this increase may correspond to similarity. Thus, higher values for the similarity metric may correspond to better candidates for frame skipping.

In accordance with this disclosure, if the value of the similarity metric is larger than a first similarity threshold T₁, frame skip unit 55 may cause this frame to be skipped regardless of the type of frame. In this case, frame skip unit 55 may send a control signal to predictive decoder 68 to cause the decoding of that frame to be skipped, or may send a control signal to post processing unit 56 to cause the post processing of that frame to be skipped. When post processing is skipped, the frame is never sent from post processing unit 56 to drive display unit 58. When decoding is skipped, the frame is never sent to post processing unit 56 or to display unit 58.

If the similarity metric is smaller than threshold T₁, frame skip unit 55 may further check to see whether the similarity metric is larger than a second similarity threshold T₂, wherein T₂<T₁. If the similarity metric is less than threshold T₂, this may indicate that the current frame is quite different from the previous frame (e.g., a previous non-skipped frame of a sequence of frames) and that current frame should be skipped even if that current frame is a reference frame. However, if the similarity metric is less than threshold T₁ and greater than threshold T₂, frame skip unit 55 may further determine whether the current frame is a reference frame. If the current frame is a reference frame with a similarity metric that is greater than threshold T₂, then device 50 may reconstruct, post process, and display that frame. If the current frame is not a reference frame and has a similarity metric is less than threshold T₁ and larger than threshold T₂ then device 50 may avoid decoding, reconstruction, post processing, and display of that frame. In this case, if frame skip unit 55 determines that the current frame is not a reference frame and has a similarity metric that is less than threshold T₁ and larger than threshold T₂, then frame skip unit 55 may send one or more control signals to cause predictive decoder 68, post processing unit 56, and display unit 58 to skip that frame. In this way, a higher threshold T₁ applies to all frames including non-reference frames, and a lower threshold T₂ applies only to non-reference frames. This makes it less likely to skip reference frames and more likely to skip non-reference frames unless the current non-reference frame is very different than the adjacent frame.

In some cases, power information may be provided to frame skip unit 55 in order to make more informed decisions regarding frame skipping. For example, if device 50 is low on power, it may be more desirable to be aggressive in the frame skipping in order to conserve power. On the other hand, if device 50 has ample power or is currently being recharged by an external power source, it may be less desirable to implement frame skipping. Although a power source is not illustrated in FIG. 3, the power information may be considered to be part of “supplemental information” shown in FIG. 3. In this case, “supplemental information” may include a measure of the current power available to device 50, and possibly a measure of the current rate of power usage. In this case thresholds T₁ and T₂ may be defined or adjusted based on the power available to device 50. If the available power is sufficient to support very high frame rates, thresholds T₁ and T₂ can be increased to make frame skipping less likely. On the other hand, if available power is low, thresholds T₁ and T₂ may be lowered to promote power conservation. In this way, one or more similarity thresholds compared to the similarity metric may be an adjustable threshold that adjusts based on available battery power in decoding device 50.

Moreover, in some cases, decoding device 50 may determine a frame rate of the video sequence. In this case, frame skip unit 55 may generate the similarity metric and cause skipping of the current video frame subject to the similarity metric satisfying the threshold only when the frame rate of the video sequence exceeds a frame rate threshold. In this way, device 50 may ensure that a lower limit is established for the frame rate such that frame skipping is avoided below a particular frame rate. Accordingly, frame skip unit 55 may cause device 50 to skip a current video frame subject to the similarity metric satisfying the threshold only when skipping the current video frame will not reduce a frame rate below a frame rate threshold. Furthermore, in some cases, the bit rate associated with a video sequence may be used to by frame skip unit 55 in order to make frame skipping decisions. In this case, the bit rate may be compared to a bit rate threshold, below which frame skipping is avoided. Bit rates may differ from frame rates particularly when frames are coded at different levels of quantization or define different levels of motion that cause bit rates of different frames to vary substantially from frame to frame.

As noted, the illustrated “supplemental information” may comprise an indication of available battery power. However, “supplemental information” may comprise a wide variety of other information, such as indications of corrupted frames. In this case, frame skip unit 55 may identify supplemental information associated with the current video frame indicating that the current frame is corrupted, and cause device 55 to skip the current video frame when the supplemental information indicates that the current frame is corrupted. Frame corruption, for example, may be determined by a communication unit (such as communication unit 21 of FIG. 1) determining that received data does not comply with an expected data format, or could be determined in other ways.

The discussion of FIG. 3 generally applies to the decoder. However, a similarity metric similar to that described above could also be used in a system like that of FIG. 2 in which frame skipping is employed by an encoding device in order to identify frames to skip in the transmission of a video sequence. In the case of an encoding device, a frame skip unit in the encoding device can facilitate intelligent selection of frames to skip, e.g., so that the encoding device can meet bandwidth constraints for the transmission of a coded video sequence.

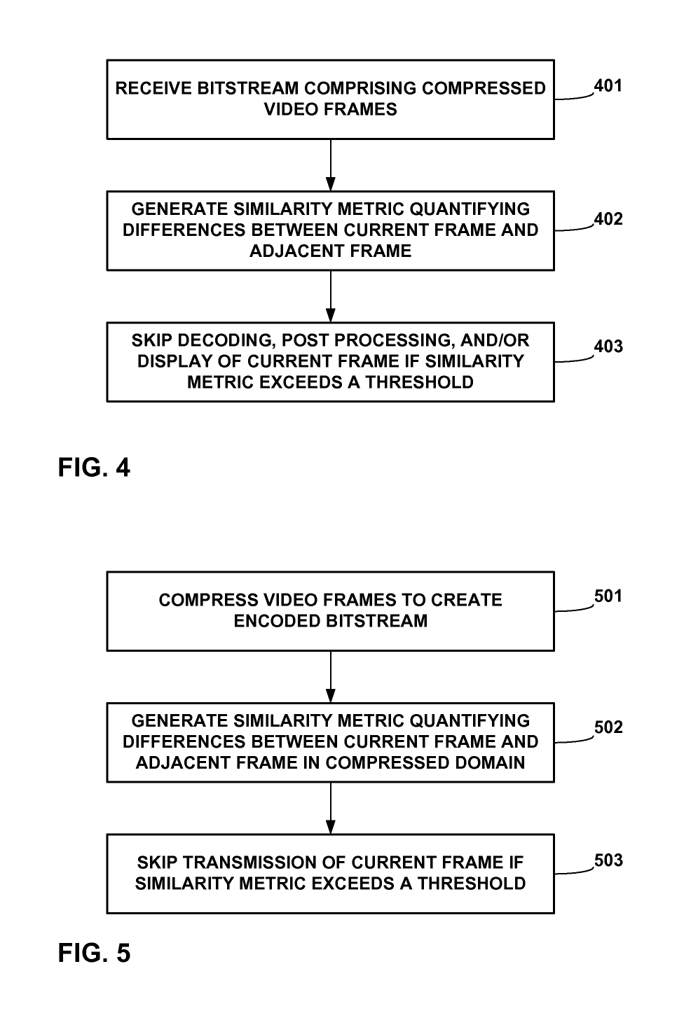

FIG. 4 is a flow diagram illustrating a frame skipping technique that may be executed in a decoder device such as video decoder device 22 of FIG. 1 or decode device 50 of FIG. 3. The discussion of FIG. 4 will refer to video decoder device 22 of FIG. 1 for exemplary purposes.

As shown in FIG. 4, communication unit 21 of video decoder device 22 receives a bitstream comprising compressed video frames (401). Frame skip unit 26 generates a similarity metric, such as that discussed above, in order to quantify differences between a current frame and an adjacent frame (402). For example, the adjacent frame may comprise a previous frame in the video sequence that is temporally adjacent to the current frame. If the similarity metric exceeds a similarity threshold, frame skip unit 26 sends one or more control signals to cause video decoder device 22 to skip decoding, post processing, and/or display of the current frame (403). In this way, the similarity metric facilitates intelligent frame skipping decisions in video decoder device 22.

FIG. 5 is a flow diagram illustrating a frame skipping technique that may be executed in an encoder device such as video encoder device 32 of FIG. 2. As shown in FIG. 5, encode unit 36 of video encoder device 32 compresses video frames to create an encoded bitstream (501). Frame skip unit 37 generates a similarity metric quantifying differences between a current frame and an adjacent frame of the encoded bitstream in the compressed domain (502). Frame skip unit 37 then causes communication unit 39 of device 32 to skip transmission of the current frame if the similarity metric exceeds a similarity threshold (503). In this way, the techniques of this disclosure may allow an encoding device to reduce the encoding frame rate to promote efficient use of bandwidth without substantial degradations in video quality.

The various frame skipping techniques of this disclosure may also be used in transcoding applications. In this case, a compressed bitstream may be coded according to one standard (e.g., MPEG-2), but may be decoded and then re-encoded according to a second standard (e.g., ITU-T H.264). In this case, the frame skipping techniques of this disclosure may be used to avoid the decoding and/or re-encoding of some frames either for frame rate power saving reasons at the decoder stage, or for resource or bandwidth constraints at the encoder stage.

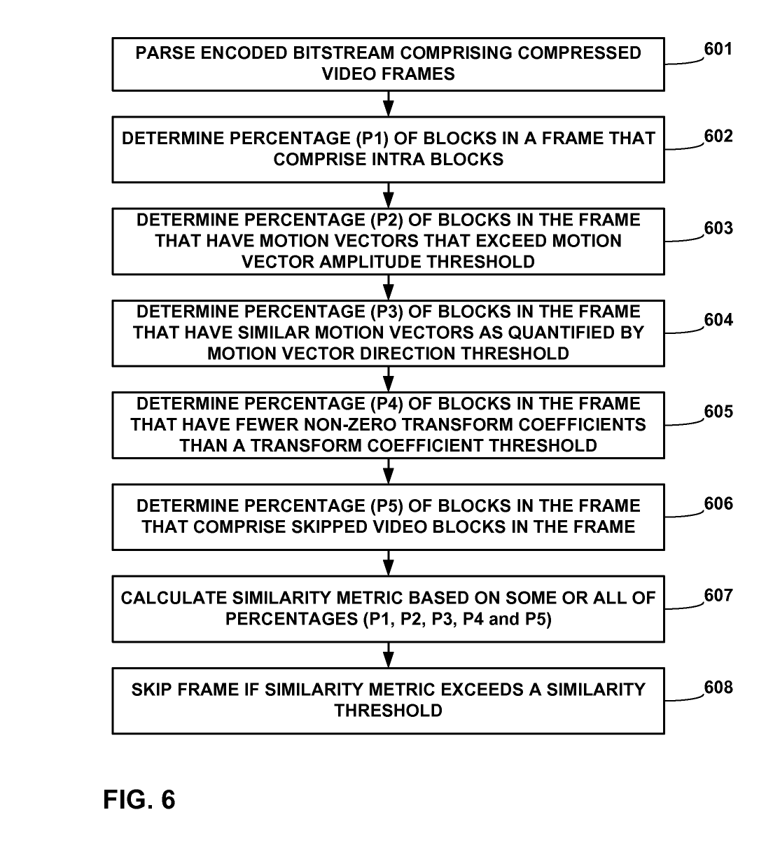

FIG. 6 is a flow diagram illustrating a technique for generating an exemplary similarity metric and performing frame skipping based on the similarity metric. The technique of FIG. 6 could be performed by a video encoder device like device 32 of FIG. 2, or by a video decoder device such as device 22 of FIG. 1 or decode device 50 of FIG. 3. For explanation purposes, the technique of FIG. 6 will be described from the perspective of decode device 50 of FIG. 3.

As shown in FIG. 6, bitstream parser 62 parses an encoded bitstream comprising compressed video frames (601). This parsing identifies syntax and/or data of the encoded bitstream in the compressed domain. Frame skip unit 55 uses the parsed data in the compressed domain in order to generate a similarity metric indicative of similarities between a current frame and an adjacent frame to the current frame. In particular, frame skip unit 55 determines a percentage P1 of blocks in a frame that comprise intra blocks (602). Frame skip unit 55 also determines a percentage P2 of blocks in the frame that have motion vectors that exceed a motion vector magnitude threshold (603), and determines a percentage P3 of blocks in the frame that have similar motion vectors as quantified by a motion vector direction threshold (604). In addition, frame skip unit 55 determines a percentage P4 of blocks in the frame that have fewer non-zero transform coefficients than a non-zero coefficient threshold (604). Optionally, frame skip unit 55 may also determine a percentage P5 of blocks in the frame that comprise skipped video blocks in the frame (605).

Using some or all of theses percentages (P1, P2, P3, P4 and P5), frame skip unit 55 calculates a similarity metric quantifying differences between a current frame and an adjacent frame (606). All of the information needed to generate P1, P2, P3, P4 and P5 may comprise data of an encoded bitstream in a compressed domain, including syntax and compressed transform coefficients. Therefore, decoding of the data to a pixel domain is not needed to generate the similarity metric. In some cases, the similarity metric may have weight factors assigned to the different percentages determined by frame skip unit 55. A more detailed example of one similarity metric is discussed above.

In any case, frame skip unit can cause device 50 to skip the frame if the similarity metric exceeds a similarity threshold (607). For example, frame skip unit 55 may send control signals to predictive decoder 68 to cause predictive decoder 68 to skip the decoding of the frame, or may send control signals to post processing unit 56 to cause post processing unit 56 to skip the post processing of the frame. In the former case, decoding, post processing and display of the frame is avoided. In the later case, decoding of the frame is performed, but post processing and display of the frame is avoided. In both of these cases, power conservation is promoted by frame skipping, and the frame selection for such frame skipping can reduce quality degradation due to such frame skipping.

In some cases, it may be unknown whether or not frame skipping is needed to conserve power when a frame is being decoded. Following the decoding, however, if power conservation is needed, it may be desirable to skip post processing and display of decoded frames. The frame skipping decision may be made in the compressed domain, e.g., based on uncompressed encoded data and syntax. Then, even following the decoding of that data, frame skipping of the post processing and display of the frame may be desirable.

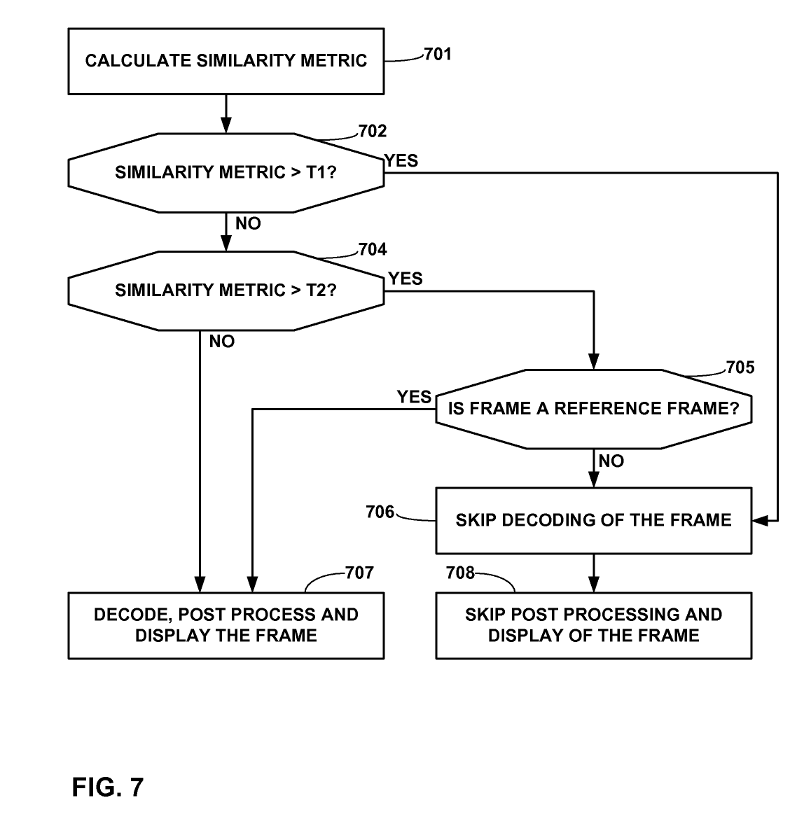

FIG. 7 is a flow diagram illustrating a frame skipping technique that may be executed by a decoder device such as video decoder device 22 of FIG. 1 or decode device 50 of FIG. 3. The discussion of FIG. 7 will refer to decode device 50 of FIG. 3 for exemplary purposes.

As shown in FIG. 7, frame skip unit 55 of decode device 50 calculates a similarity metric indicative of similarities between a current frame and an adjacent frame to the current frame (701). As described herein, the similarity metric may be based solely on compressed data of the current frame, e.g., data in the compressed domain such as syntax regarding video block types, motion vector magnitudes and directions, quantization parameters used in the coding, and quantized residual transform coefficients associated with video blocks.

Frame skip unit 55 determines whether the similarity metric satisfies a first threshold T1 (702). If the similarity metric satisfies the first threshold T1 (“yes” 702), frame skip unit 55 sends control signals to predictive decoder 68 that cause device 50 to skip decoding of the frame (706) and therefore, also skip post processing and display of the frame (708). In particular, in response to a skip command from frame skip unit 55, predictive decoder 68 skips decoding for that frame (706). In this case, post processing unit 56 and display unit 58 never receive data for the frame, and therefore do not post process the frame and do not display that frame (708).

If the similarity metric does not satisfy the first threshold T1 (“no” 702), frame skip unit 55 determines whether the similarity metric satisfies a second threshold T2 (704). In this case, if the similarity metric does not satisfy the second threshold T2 (“no” 704), the frame is decoded, post processed, and displayed (707). In particular, if the similarity metric does not satisfy the second threshold T2 (“no” 704), the frame may be decoded by predictive decoder 68, post processed by post processing unit 56, and displayed by display unit 58.

If the similarity metric satisfies the second threshold T2 (“yes” 704), frame skip unit 55 determines whether the frame is a reference frame. If so (“yes” 705), the frame is decoded, post processed, and displayed (707). In particular, if the similarity metric satisfies the second threshold T2 (“yes” 704) and the frame is a reference frame (“yes” 705), the frame may be decoded by predictive decoder 68, post processed by post processing unit 56, and displayed by display unit 58.

However, if the similarity metric satisfies the second threshold T2 (“yes” 704), but the frame is not a reference frame (“no” 705), device 50 is caused to skip decoding of the frame (706) and skip post processing and display of the frame (708). Accordingly, non-reference frames whose similarity metrics do not satisfy the first threshold T1 (“no” 703) but do satisfy the second threshold (“yes” 704) are not decoded, post processed or displayed. In this way, a higher threshold T₁ applies to all frames including non-reference frames, and a lower threshold T₂ applies only to non-reference frames. This makes it less likely to skip reference frames and more likely to skip non-reference frames unless the current non-reference frame is very different than the adjacent frame. Since reference frames are used to code other frames, frame skipping of reference frames may be less desirable. Therefore, frame skipping of reference frames may only done when the reference frames have a similarity metric that exceeds the higher threshold T₁, while non-reference frames may be skipped if they have a similarity metric that exceeds either threshold T₁ or T₂.

The similarity metric and thresholds are typically defined such that the value of the similarity metric satisfies a given threshold when the value of the similarity metric exceeds the value of the given threshold. However, alternatively, the similarity metric and thresholds could be defined such that the value of the similarity metric satisfies the given threshold when the value of the similarity metric is less than the value of the given threshold.

In still other examples, other variations on the specific frames that are skipped and how such frames are skipped could be implemented based on the teaching of this disclosure. The flow diagram of FIG. 7 is merely one example. Furthermore, the frame skipping could occur in post processing unit 56 following a decode by predictive decoder 68, or in display unit 58 following predictive decode by predictive decoder 68 and post processing by post processing unit 56. In these cases, data in the compressed domain facilitates frame skipping in the decoded and uncompressed domain.

The techniques described herein may be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. If implemented in hardware, this disclosure may be directed to an apparatus such a processor or an integrated circuit device, such as an integrated circuit chip or chipset. Alternatively or additionally, if implemented in software, the techniques may be realized at least in part by a computer-readable medium comprising instructions that, when executed, cause a processor to perform one or more of the methods described above. For example, the computer-readable medium may store such instructions.

A computer-readable medium may form part of a computer program product, which may include packaging materials. A computer-readable medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules. The disclosure also contemplates any of a variety of integrated circuit devices that include circuitry to implement one or more of the techniques described in this disclosure. Such circuitry may be provided in a single integrated circuit chip or in multiple, interoperable integrated circuit chips in a so-called chipset. Such integrated circuit devices may be used in a variety of applications, some of which may include use in wireless communication devices, such as mobile telephone handsets.

Various aspects of the disclosed techniques have been described. These and other aspects are within the scope of the following claims.

1. A method comprising:
generating a similarity metric that quantifies similarities between a current video frame and an adjacent frame of a video sequence, wherein the similarity metric is based on data within a compressed domain indicative of differences between the current frame and the adjacent frame; and
skipping the current video frame subject to the similarity metric satisfying a threshold.

2. The method of claim 1, wherein the method is an encoding method, and wherein skipping the current video frame comprises skipping transmission of the current video frame to another device.

3. The method of claim 1, wherein the method is a decoding method, and wherein skipping the current video frame comprises skipping predictive decoding of the current video frame.

4. The method of claim 1, wherein the method is a decoding method, and wherein skipping the current video frame comprises skipping post processing of the current video frame.

5. The method of claim 1, wherein the method is a decoding method, and wherein skipping the current video frame comprises skipping display of the current video frame.

6. The method of claim 1, wherein the similarly metric is based on:
a percentage of intra video blocks in the current video frame;
a percentage of video blocks in the current video frame that have motion vectors that exceed a motion vector magnitude threshold;
a percentage of video blocks in the current video frame that have motion vectors that are sufficiently similar in direction as quantified by a motion vector direction threshold; and a percentage of video blocks in the current video frame that include fewer non-zero transform coefficients than one or more non-zero coefficient thresholds.

7. The method of claim 6, wherein the one or more non-zero coefficient thresholds are functions of one or more quantization parameters associated with the video blocks in the current video frame.

8. The method of claim 6, wherein the similarly metric (SM) comprises:
SM=W1*IntraMBs %+W2*MVs_Magnitude %+W3*MVs_Samedirection %+W4*Nz %
wherein W1, W2, W3 and W4 are weight factors,
wherein IntraMBs % is the percentage of intra video blocks in the current video frame,
wherein MVs_Magnitude % is the percentage of motion vectors associated with the current video frame that exceed the motion vector magnitude threshold,
wherein MVs_Samedirection % is the percentage of motion vectors associated with the current video frame that are sufficiently similar as quantified by the motion vector direction threshold, and
Nz % is the percentage of video blocks in the current video frame that include fewer non-zero transform coefficients than the one or more non-zero coefficient thresholds.

9. The method of claim 8, wherein W1, W2, W3 and W4 are predefined based on analysis of frame skipping in one or more test video sequences.

10. The method of claim 9, wherein W1, W2, W3 and W4 are predefined to have different values for different types of video motion based on analysis of frame skipping in one or more test video sequences.

11. The method of claim 6, wherein the similarly metric is based on a percentage of video blocks in the current video frame that comprise skipped video blocks within the current video frame.

12. The method of claim 1, wherein the method is a decoding method, and wherein skipping the current video frame comprises:
skipping the current video frame when the similarity metric is greater than a first threshold; and
skipping the current video frame when the similarity metric is greater than a second threshold and the frame is not a reference frame used for predictive coding of one or more other frames.

13. The method of claim 1, wherein the method is a decoding method implemented by a decoding device, and wherein the threshold is an adjustable threshold that adjusts based on available battery power in the decoding device.

14. The method of claim 1, further comprising:
determining a frame rate of the video sequence; and
generating the similarity metric and skipping the current video frame subject to the similarity metric satisfying the threshold only when the frame rate of the video sequence exceeds a frame rate threshold.

15. The method of claim 1, further comprising:
identifying supplemental information associated with the current video frame indicating that the current frame is corrupted; and
skipping the current video frame when the supplemental information indicates that the current frame is corrupted.

16. The method of claim 1, further comprising
skipping the current video frame subject to the similarity metric satisfying the threshold only when skipping the current video frame will not reduce a frame rate below a frame rate threshold.

17. An apparatus comprising:
a frame skip unit that generates a similarity metric that quantifies similarities between a current video frame and an adjacent frame of a video sequence, wherein the similarity metric is based on data within a compressed domain indicative of differences between the current frame and the adjacent frame, and causes the apparatus to skip the current video frame subject to the similarity metric satisfying a threshold.

18. The apparatus of claim 17, wherein the apparatus is an encoding apparatus, wherein the frame skip unit generates a control signal that causes a communication unit to skip transmission of the current video frame to another device.

19. The apparatus of claim 17, wherein the apparatus is a decoding apparatus, wherein the frame skip unit generates a control signal that causes a predictive decoder to skip predictive decoding of the current video frame.

20. The apparatus of claim 17, wherein the apparatus is a decoding apparatus, wherein the frame skip unit generates a control signal that causes a post processing unit to skip post processing of the current video frame.

21. The apparatus of claim 17, wherein the apparatus is a decoding apparatus, wherein the frame skip unit generates a control signal that causes a display unit to skip display of the current video frame.

22. The apparatus of claim 17, wherein the similarly metric is based on:
a percentage of intra video blocks in the current video frame;
a percentage of video blocks in the current video frame that have motion vectors that exceed a motion vector magnitude threshold;
a percentage of video blocks in the current video frame that have motion vectors that are sufficiently similar in direction as quantified by a motion vector direction threshold; and a percentage of video blocks in the current video frame that include fewer non-zero transform coefficients than one or more non-zero coefficient thresholds.

23. The apparatus of claim 22, wherein the one or more non-zero coefficient thresholds are functions of one or more quantization parameters associated with the video blocks in the current video frame.

24. The apparatus of claim 22, wherein the similarly metric (SM) comprises:
SM=W1*IntraMBs %+W2*MVs_Magnitude %+W3*MVs_Samedirection %+W4*Nz %
wherein W1, W2, W3 and W4 are weight factors,
wherein IntraMBs % is the percentage of intra video blocks in the current video frame,
wherein MVs Magnitude % is the percentage of motion vectors associated with the current video frame that exceed the motion vector magnitude threshold,
wherein MVs_Samedirection % is the percentage of motion vectors associated with the current video frame that are sufficiently similar as quantified by the motion vector direction threshold, and
Nz % is the percentage of video blocks in the current video frame that include fewer non-zero transform coefficients than the one or more non-zero coefficient thresholds.

25. The apparatus of claim 24, wherein W1, W2, W3 and W4 are predefined based on analysis of frame skipping in one or more test video sequences.

26. The apparatus of claim 25, wherein W1, W2, W3 and W4 are predefined to have different values for different types of video motion based on analysis of frame skipping in one or more test video sequences.

27. The apparatus of claim 22, wherein the similarly metric is based on a percentage of video blocks in the current video frame that comprise skipped video blocks within the current video frame.

28. The apparatus of claim 17, wherein the apparatus is a decoding apparatus, and wherein the frame skip unit causes a predictive coding unit to skip predictive coding of the current video frame when the similarity metric is greater than a first threshold, and to skip predictive decoding of the current video frame when the similarity metric is greater than a second threshold and the frame is not a reference frame used for predictive coding of one or more other frames.

29. The apparatus of claim 17, wherein the apparatus is a decoding apparatus, and wherein the threshold is an adjustable threshold that adjusts based on available battery power in the decoding apparatus.

30. The apparatus of claim 17, wherein the frame skip unit:
determines a frame rate of the video sequence; and
causes skipping of the current video frame subject to the similarity metric satisfying the threshold only when the frame rate of the video sequence exceeds a frame rate threshold.

31. The apparatus of claim 17, wherein the frame skip unit:
identifies supplemental information associated with the current video frame indicating that the current frame is corrupted; and
causes skipping of the current video frame when the supplemental information indicates that the current frame is corrupted.

32. The apparatus of claim 17, wherein the frame skip unit:
causes skipping of the current video frame subject to the similarity metric satisfying the threshold only when skipping the current video frame will not reduce a frame rate below a frame rate threshold.

33. The apparatus of claim 17, wherein the apparatus comprises an integrated circuit.

34. The apparatus of claim 17, wherein the apparatus comprises a microprocessor.

35. A device comprising:
means for generating a similarity metric that quantifies similarities between a current video frame and an adjacent frame of a video sequence, wherein the similarity metric is based on data within a compressed domain indicative of differences between the current frame and the adjacent frame; and
means for skipping the current video frame subject to the similarity metric satisfying a threshold.

36. The device of claim 35, wherein the similarly metric is based on:
a percentage of intra video blocks in the current video frame;
a percentage of video blocks in the current video frame that have motion vectors associated that exceed a motion vector magnitude threshold;
a percentage of video blocks in the current video frame that have motion vectors that are sufficiently similar in direction as quantified by a motion vector direction threshold; and a percentage of video blocks in the current video frame that include fewer non-zero transform coefficients than one or more non-zero coefficient thresholds.

37. The device of claim 36, wherein the one or more non-zero coefficient thresholds are functions of one or more quantization parameters associated with the video blocks in the current video frame.

38. The device of claim 36, wherein the similarly metric (SM) comprises:
SM=W1*IntraMBs %+W2*MVs_Magnitude %+W3*MVs_Samedirection %+W4*Nz %
wherein W1, W2, W3 and W4 are weight factors,
wherein IntraMBs % is the percentage of intra video blocks in the current video frame,
wherein MVs_Magnitude % is the percentage of motion vectors associated with the current video frame that exceed the motion vector magnitude threshold,
wherein MVs_Samedirection % is the percentage of motion vectors associated with the current video frame that are sufficiently similar as quantified by the motion vector direction threshold, and
Nz% is the percentage of video blocks in the current video frame that include fewer non-zero transform coefficients than the one or more non-zero coefficient thresholds.

39. The device of claim 35, wherein the device is a decoding device, and wherein means for skipping the current video frame comprises:
means for skipping the current video frame when the similarity metric is greater than a first threshold; and
means for skipping the current video frame when the similarity metric is greater than a second threshold and the frame is not a reference frame used for predictive coding of one or more other frames.

40. The device of claim 35, wherein the device is a decoding device, and wherein the threshold is an adjustable threshold that adjusts based on available battery power in the decoding device.

41. A computer-readable medium comprising instructions that when executed cause a device to:
generate a similarity metric that quantifies similarities between a current video frame and an adjacent frame of a video sequence, wherein the similarity metric is based on data within a compressed domain indicative of differences between the current frame and the adjacent frame, and
skip the current video frame subject to the similarity metric satisfying a threshold.

42. The computer-readable medium of claim 41, wherein the similarly metric is based on:
a percentage of intra video blocks in the current video frame;
a percentage of video blocks in the current video frame that have motion vectors associated that exceed a motion vector magnitude threshold;
a percentage of video blocks in the current video frame that have motion vectors that are sufficiently similar in direction as quantified by a motion vector direction threshold; and a percentage of video blocks in the current video frame that include fewer non-zero transform coefficients than one or more non-zero coefficient thresholds.

43. The computer-readable medium of claim 42, wherein the similarly metric (SM) comprises:
SM=W1*Intra MBs%+W2*MVs-hd —Magnitude %+W3*MVs_Samedirection %+W4*Nz %
wherein W1, W2, W3 and W4 are weight factors,
wherein IntraMBs % is the percentage of intra video blocks in the current video frame,
wherein MVs_Magnitude % is the percentage of motion vectors associated with the current video frame that exceed the motion vector magnitude threshold,
wherein MVs_Samedirection % is the percentage of motion vectors associated with the current video frame that are sufficiently similar as quantified by the motion vector direction threshold, and
Nz % is the percentage of video blocks in the current video frame that include fewer non-zero transform coefficients than the one or more non-zero coefficient thresholds.

44. The computer-readable medium of claim 41, wherein the device is a decoding device, wherein the instructions cause the device to:
skip predictive coding, post processing and display of the current video frame when the similarity metric is greater than a first threshold; and
skip predictive decoding, post processing, and display of the current video frame when the similarity metric is greater than a second threshold and the frame is not a reference frame used for predictive coding of one or more other frames.

45. The computer-readable medium of claim 41, wherein the device is a decoding device, and wherein the threshold is an adjustable threshold that adjusts based on available battery power in the decoding device.

46. The computer-readable medium of claim 41, wherein the instructions cause the device to:
determine a frame rate of the video sequence; and
skip the current video frame subject to the similarity metric satisfying the threshold only when the frame rate of the video sequence exceeds a frame rate threshold.

47. An encoding device comprising:
a frame skip unit that generates a similarity metric that quantifies similarities between a current video frame and an adjacent frame of a video sequence, wherein the similarity metric is based on data within a compressed domain indicative of differences between the current frame and the adjacent frame, and
a communication unit that skips transmission of the current video frame subject to the similarity metric satisfying a threshold.

48. The encoding device of claim 47, wherein the device comprises a wireless communication handset.

49. An decoding device comprising:
a communication unit that receives compressed video frames of a video sequence; and
a frame skip unit that:
generates a similarity metric that quantifies similarities between a current video frame and an adjacent frame of the video sequence, wherein the similarity metric is based on data within a compressed domain indicative of differences between the current frame and the adjacent frame, and
causes the device to skips of the current video frame subject to the similarity metric satisfying a threshold.

50. The decoding device of claim 49, wherein the device comprises a wireless communication handset.
